(19) United States
(12) Patent Application Publication
(10) Pub. No.: US 2008/0011564 A1
(43) Pub. Date: Jan. 17, 2008

(54) Damping Structure for Drawers

(76) Inventors: Wan-Lai Chen, Taipei Hsien (TW); Tsung-Po Chang, Taipei Hsien (TW)

Correspondence Address: HDSL, 4331 STEVENS BATTLE LANE, FAIRFAX, VA, 22033, US

(21) Appl. No.: 11/456,579

(22) Filed: Jul. 11, 2006

(51) Int. Cl. F16F 9/32

(52) U.S. Cl. 188/300

(57) ABSTRACT

A damping structure for drawers includes a front portion, a slide portion, a rear portion, at least one spring member and a damping unit. When a user closes a drawer, the push portion of the track presses against the positioning rod, and then the positioning rod is pushed out of the perpendicular slot and is moved backwards due to the restoring force exerted by the two spring members. Now, the fast backward motion of the slide portion may be damped and slowed down due to the damping effect of the damping unit, and hence the drawer may be closed at a reduced speed and in a steady manner.

### BACKGROUND OF THE INVENTION

1. Field of the Invention

The invention generally relates to a damping structure for drawers. More particularly, the invention relates to a damping structure that is fitted on the track of a drawer and that has a damping unit, which may reduce the closing speed of the drawer so as to protect the track from the damages that may be caused by the high closing speed of the drawer.

2. Description of Related Art

Drawers are often fitted with one or more tracks so as to facilitate the opening and closing of them. When a drawer is closed along a track, the drawer tends to be slightly off the track. To overcome this disadvantage, a returning mechanism is fitted onto the rear part of the track of a drawer so that the drawer may be closed swiftly.

However, the returning mechanism has the following three disadvantages:
1. In the prior art, a spring is used to ensure the drawer would not be slightly off the track. However, such spring usually has a restoring force that is too large; hence, the fast closing speed of the drawer may easily damage the track and hence shorten the service life of the track.
2. If a user closes a drawer in a slanted manner or the track is fitted in a skew manner, the drawer (usually made of wood or thin metal sheet) may be damaged due to the fast closing speed of the drawer along the track.
3. A lot of noise may be generated when the drawer is closed at a fast speed. Especially during night times or in a quiet indoor environment, such noise may greatly affect the peace and quiet of the ambient surrounding.

To eliminate the disadvantages of the returning mechanism of the prior art, the inventor has put in a lot of effort in the subject and has successfully come up with the damping structure of the present invention.

### SUMMARY OF THE INVENTION

The present invention is to provide a damping structure that is fitted on the track of a drawer so as to reduce the closing speed of the drawer and protect the track as well as to lengthen the service life and reduce the noise.

The damping structure of the present invention comprises a front portion, a slide portion, a rear portion, at least a spring member and a damping unit. The front portion is affixed to the base portion of a track, and a slot and a perpendicular slot perpendicular to the length of the slot are provided on the top surface of the front portion. The slide portion is disposed on the underside of the front portion, and a positioning rod is provided on the slide portion and passes through the slot so as to guide the motion of the slide portion, and a first hook member is disposed on either side of the slide portion. The rear portion is disposed behind the rear part of the front portion and is affixed to the base portion of the track, and a second hook member is disposed on either side of the rear portion. The two ends of each of the at least one spring member are connected with a first hook member and a second hook member. The damping unit is fixedly disposed on the rear portion and is connected with the slide portion.

When a user closes a drawer, the positioning rod is pushed out of the perpendicular slot and the slide portion is moved backwards due to the restoring force exerted by the spring member. Now, the fast backward motion of the slide portion may then be damped and slowed down due to the damping effect of the damping unit so that the drawer may be closed at a reduced speed.

### BRIEF DESCRIPTION OF THE DRAWINGS

The drawings disclose an illustrative embodiment of the present invention which serves to exemplify the various advantages and objects hereof, and are as follows:

FIG. 1 is a perspective view of the damping structure of the present invention, with the damping structure attached to a track.

FIG. 2 is another perspective view of the damping structure of the present invention, with the damping structure attached to a track.

FIG. 3 is a perspective view of the damping structure of the present invention.

FIG. 4 is an exploded view of the damping structure of the present invention.

FIG. 5 is an exploded view of another embodiment of the damping structure of the present invention.

### DETAILED DESCRIPTION OF THE PREFERRED EMBODIMENT

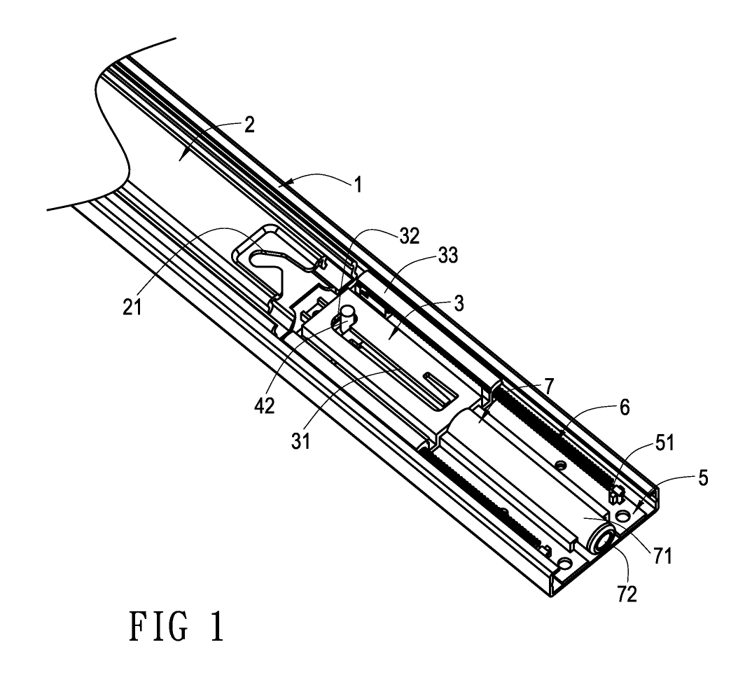

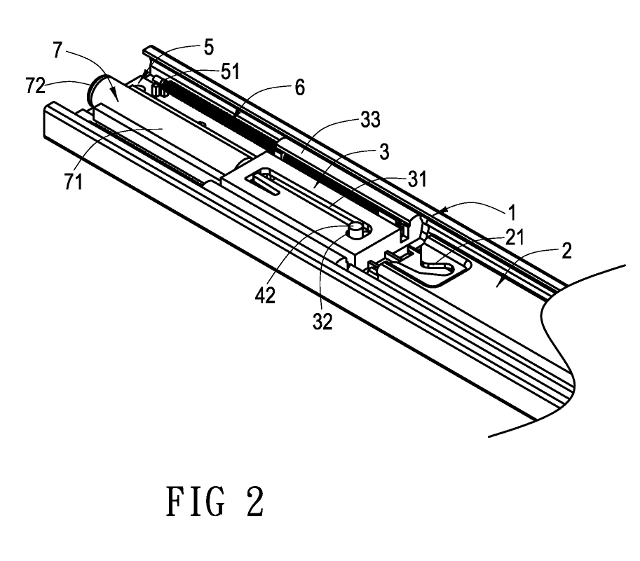

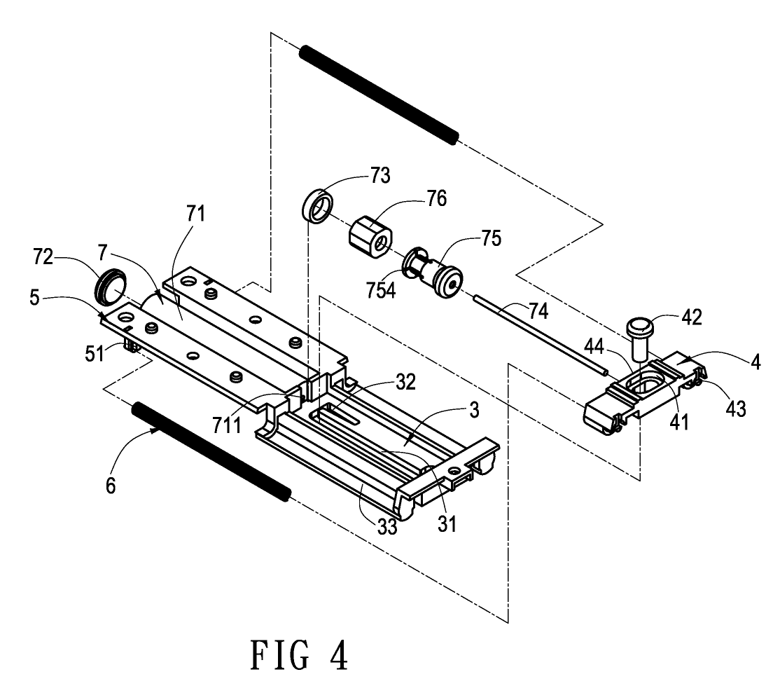

The present invention may become more understandable if the following description is read with reference to the drawings. As showed from FIGS. 1 to 4, the damping structure of the present invention is disposed at the rear end of the base portion 1 of a track 2 and corresponds to a push portion 21 of the track 2. The damping structure of the present invention comprises a front portion 3, a slide portion 4, a rear portion 5, two spring members 6 and a damping unit 7. The front portion 3, rear portion 5 and damping unit 7 are assembled together.

The front portion 3 is affixed to the base portion 1. A slot 31 is provided on the top surface of the front portion 3. A perpendicular slot 32 perpendicular to the length of the slot 31 extends from the slot 31. A side portion 33 is provided on either side of the front portion 3.

The slide portion 4 is disposed on the underside of the front portion 3. At least one hole 41 is provided in the slide portion 4. A positioning rod 42 passes through the hole 41 and the slot 31 so as to guide the motion of the slide portion 4. A first hook member 43 is disposed on either side of the slide portion 4. A hole 44 is provided on the rear side of the slide portion 4.

The rear portion 5 is disposed behind the rear part of the front portion 3 and is affixed to the base portion 1. A second hook member 51 is disposed on either side of the rear portion 5.

Either of the two spring members 6 is a pull-resisting spring. The two ends of either of the two spring members 6 are connected with a first hook member 43 and a second hook member 51.

The damping unit 7 includes a pneumatic cylinder. The damping unit 7 is fixedly disposed on the rear portion 5 and is connected with the slide portion 4. The damping unit 7 comprises a cylindrical portion 71, a front hole 711, a rear cap 72, a gasket 73, a rod 74, a piston 75 and an anti-leakage rubber member 76. The cylindrical portion 71 is fixedly disposed on the rear portion 5 and forms an air chamber therein. The front hole 711 is provided at the front end of the cylindrical portion 71. The rear cap 72 is disposed at the rear end of the cylindrical portion 71. The gasket 73 is disposed inside the cylindrical portion 71. The rod 74 is disposed inside the cylindrical portion 71 and has a diameter slightly smaller than that of the front hole 711 so that the rod 74 may pass through the front hole 711 and then be inserted into the hole 44 of the slide portion 4. The piston 75 is disposed inside the cylindrical portion 71 and is connected with the rod 74. A plurality of outlets 754 are provided on the rear side of the piston 75. The anti-leakage rubber member 76 is disposed between the piston 75 and the gasket 73.

We will now elaborate on how the damping structure of the present invention works with reference to FIG. 1 to 4. When a user closes a drawer, he pushes the drawer along the track 2 along the base portion 1. Now, the push portion 21 of the track 2 presses against the positioning rod 42. Then, the positioning rod 42 is pushed out of the perpendicular slot 32 and is moved backwards due to the restoring force exerted by the two spring members 6. Also, because the slide portion 4 is connected with the damping unit 7 through the rod 74 and the hole 44, the fast backward motion of the slide portion 4 may then be damped and slowed down due to the damping effect of the damping unit 7 (the rod 74 can push the piston 75 backwards in the cylindrical portion 71; then, the air in the cylindrical portion 71 is compressed and escapes from the outlets 754 provided on the rear side of the piston 75). Whence, the drawer may be moved to its closure position in a damped and steady manner.

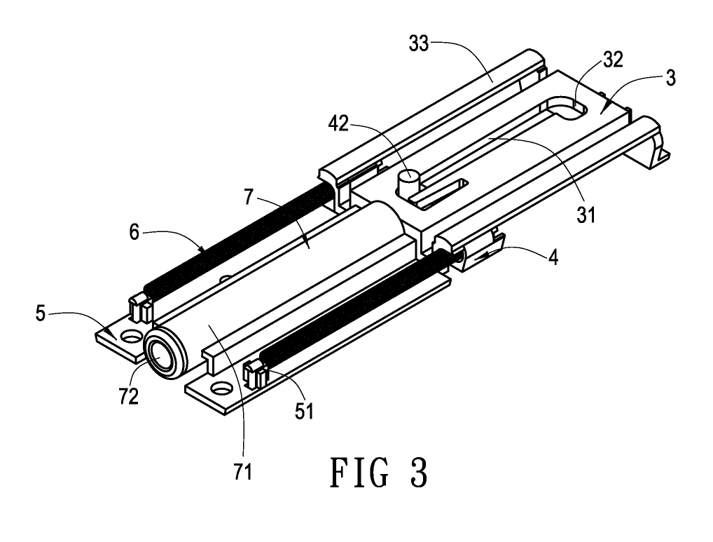

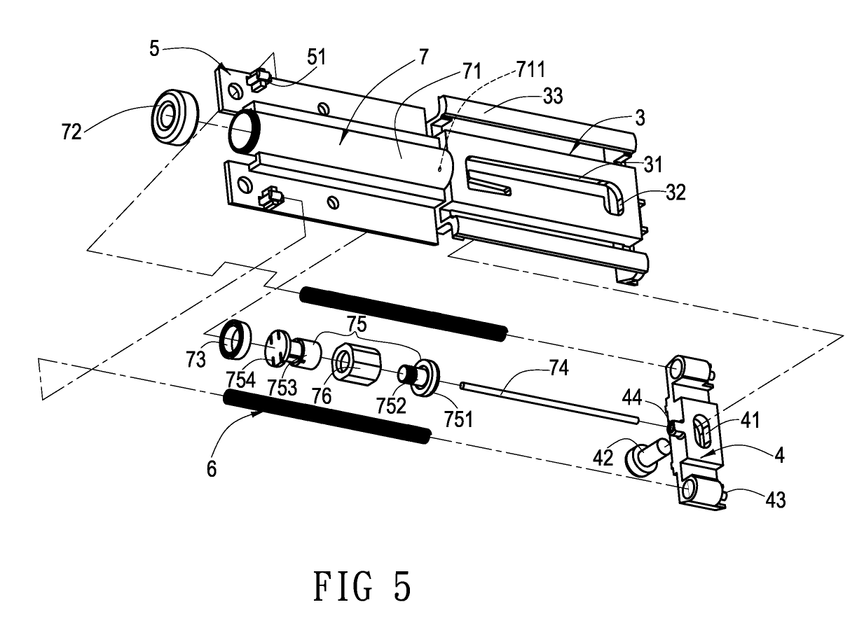

Another embodiment of the damping unit 7 of the present invention is illustrated in FIGS. 3 and 5. The piston 75 comprises a front member 751, a seating member 753, a plurality of outlets 754 and an anti-leakage rubber member 76. A hollow tubular portion 752 extends from the rear side of the front member 751 so that the rod 74 may be tightly fitted in the hollow tubular portion 752. The hollow tubular portion 752 is seated in the seating member 753. The outlets 754 are provided behind the seating member 753. The anti-leakage rubber member 76 is disposed between the front member 751 and the seating member 753.

The embodiment may enhance the level of air-tightness of the damping unit 7 so that the fast backward motion of the slide portion 4 may be damped and slowed down more effectively when the slide portion 4 is moved backwards by the restoring force exerted by the two spring members 6.

The damping structure of the present invention has the following three advantages:
1. Because the fast backward motion of the slide portion 4 may be damped and slowed down by the damping unit 7, the wear and tear by the slide portion 4 on the front portion 3 and by the track 2 on the base portion 1 will be reduced and hence the service life may be lengthened.
2. The damping effect of the present invention can reduce the damage due to the improper use (such as if a user closes a drawer in a slanted manner) of the drawer.
3. Because a drawer may be closed at a reduced speed and in a steady manner, less amount of noise is produced.

Although a preferred embodiment of the present invention has been described in detail hereinabove, it should be understood that the preferred embodiment is to be regarded in an illustrative manner rather than a restrictive manner, and all variations and modifications of the basic inventive concepts herein taught still fall within the scope of the present invention.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A damping structure for drawers, disposed at a rear portion of a base portion of a track and in alignment with a push portion of a track, comprising:
a front portion, affixed to the base portion, wherein a slot and a perpendicular slot perpendicular to a length of the slot are provided on a top surface of the front portion;
a slide portion, disposed on an underside of the front portion, wherein a positioning rod is provided on the slide portion and passes through the slot so as to guide motion of the slide portion, and wherein a first hook member is disposed on either side of the slide portion;
a rear portion, disposed behind the rear part of the front portion and affixed to the base portion, wherein a second hook member is disposed on either side of the rear portion;
at least one spring member with two ends connected with a first hook member and a second hook member, respectively; and
a damping unit, fixedly disposed on the rear portion and connected with the slide portion,
when a user closes a drawer, the positioning rod is pushed out of the perpendicular slot and the slide portion is moved backwards due to restoring force exerted by the spring member and fast backward motion of the slide portion is then damped and slowed down due to damping effect of the damping unit so that the drawer is closed at a reduced speed and in a steady manner.

2. The damping structure for drawers as in claim 1, wherein a side portion is provided on either side of the front portion.

3. The damping structure for drawers as in claim 1, wherein at least one hole is provided in the slide portion such that the positioning rod passes through the hole and the slot.

4. The damping structure for drawers as in claim 1, wherein the damping unit includes a pneumatic cylinder.

5. The damping structure for drawers as in claim 4, wherein the damping unit comprises:
a cylindrical portion, fixedly disposed on the rear portion and forming an air chamber therein, wherein a front hole is provided at a front end of the cylindrical portion;
a rear cap, disposed at a rear end of the cylindrical portion;
a gasket, disposed inside the cylindrical portion;
a rod, disposed inside the cylindrical portion and having a diameter slightly smaller than that of the front hole so that the rod passes through the front hole;
a piston, disposed inside the cylindrical portion and connected with the rod, wherein a plurality of outlets are provided on a rear side of the piston; and
an anti-leakage rubber member, disposed between the piston and the gasket.

6. The damping structure for drawers as in claim 5, wherein a hole is provided on a rear side of the slide portion and the rod is inserted into the hole.

7. The damping structure for drawers as in claim 5, wherein the piston comprises a front member, a seating member and an anti-leakage rubber member, and a hollow tubular portion extends from the rear side of the front member so that the rod is tightly fitted in the hollow tubular portion and the hollow tubular portion is seated in the seating member and that the outlets are provided behind the seating member and the anti-leakage rubber member is disposed between the front member and the seating member.

8. The damping structure for drawers as in claim 1, wherein the damping structure includes two springs and the two ends of either of the two springs are connected with a first hook member and a second hook member.

9. The damping structure for drawers as in claim 8, wherein a hole is provided in the slide portion such that the positioning rod passes through the hole.

10. The damping structure for drawers as in claim 1, wherein the spring member is a pull-resisting spring.
